(19) United States
(12) Patent Application Publication
(10) Pub. No.: US 2019/0185154 A1
(43) Pub. Date: Jun. 20, 2019

(54) INTERMESHING ROTARY-WING AIRCRAFT WITH SYMMETRICAL SWASH PLATE

(71) Applicant: Taesan KIM, SEOUL (KR)

(72) Inventor: Taesan KIM, SEOUL (KR)

(21) Appl. No.: 16/327,318

(22) PCT Filed: Nov. 14, 2016
(86) PCT No.: PCT/KR2016/013066

§ 371 Date: Feb. 21, 2019

(30) Foreign Application Priority Data
Aug. 26, 2016 (KR) 10-2016-0109576

(51) Int. Cl. B64C 27/605; B64C 27/08; B64C 27/625; F16H 23/10

(52) U.S. Cl. CPC B64C 27/605; F16H 23/10; B64C 27/625; B64C 27/08

(57) ABSTRACT

An intermeshing rotary-wing aircraft comprises a first rotary blade portion including a first blade and a second blade, a second rotary blade portion including a third blade and a fourth blade, a first shaft and a second shaft that transmit power to the first rotary portion and the second rotary portion and are symmetrically positioned at a predetermined angle, a first swash plate portion for controlling the first blade and the second blade, and a second swash plate portion for controlling the third blade and the fourth blade, wherein the first swash plate is coupled to three linkages, in which the coupled positions are located at the vertices of an equilateral triangle, the second swash plate has the same shape as the first swash plate, and the two equilateral triangles of the first swash plate and the second swash plate are star-shaped when horizontally moved and overlapped.

### TECHNICAL FIELD

The present invention relates to an intermeshing rotor helicopter using a swash plate.

### BACKGROUND ART

Recently, automatous aircrafts or drones have attracted much interest in many applications. However, due to their structural limitations, the drones hardly carry high-weighted loads, so that the number of power supply devices (e.g., batteries) being installed is limited, which makes the drones to be limited in a moving distance or speed.

Due to the aforementioned drawbacks, helicopters are more often used in industrial applications than rotorcrafts such as “drones”. However, as the helicopters use tail rotors, their output power can be reduced, and if the tail rotors fail to operate, they cannot maintain the balance.

To address the above drawbacks, an intermeshing rotor helicopter was proposed as a prior work, as shown in FIG. 1. The intermeshing rotor helicopter uses two rotating wings which are arranged to have a predetermined angle. The intermeshed rotor helicopter does not need tail rotors as it cancels anti-torque using two rotors. Therefore, the intermeshed rotor helicopter is more efficient than conventional helicopters because all engine power can be transferred into lift power without losing power by the tail rotor.

In implementing the intermeshed rotor helicopter, what is the most important technical issue is to control a driving part that drives the two rotating wings crossing obliquely and the two rotating wings. The helicopter controls its movement or direction by controlling angles of blades located at the rotating wings. The angles of the blades are controlled by a controller that controls swash plates located under the rotating wings, servos connected to the swash plates or linkages including actuators, the linkages, etc. Further, the controller controls Yawing, Rolling, Pitching and Rising/Lowering of the helicopter by controlling the angles of the blades.

As the intermeshing rotor helicopter includes two rotating wings, the controller of the intermeshing rotor helicopter should be able to control not only each of the rotating wings but also the overall part thereof at the same time. Therefore, it is impossible to control the intermeshing rotor helicopter using conventional controllers.

### DETAILED DESCRIPTION OF THE INVENTION

### Technical Problem

The technical problem of the present invention is to provide a swash plate(s) for controlling an intermeshing rotor helicopter and the helicopter including the same.

### Technical Solution

In order to address the above-mentioned technical issues, a helicopter according to an embodiment of the present invention includes a first rotating wing part, a second rotating wing part, a first shaft, a second shaft, a first swash plate part and a second swash plate part. The first rotating wing part includes a first blade and a second blade. The second rotating wing part includes a third blade and a fourth blade. The first shaft is configured to deliver power to the first rotating wing part. The second shaft is configured to deliver power to the second rotating wing part. The first swash plate part is configured to control the first blade and the second blade. The second swash plate part is configured to control the third blade and the fourth blade. The first shaft and the second shaft are symmetrically disposed to have a predetermined angle. The first swash plate part is coupled to three linkages through three points which respectively correspond to three vertexes of an equilateral triangle. The second swash plate part has a same shape as the first swash plate part, and respective equilateral triangles of the first swash plate part and the second swash plate part form a star shape when the equilateral triangles move in a horizontal direction and overlap each other.

In one embodiment, the first swash plate part includes a first upper swash plate and a first lower swash plate coupled to each other. The first lower swash plate is coupled to the three linkages through ball points. The three linkages control the first lower swash plate by using three servos. When the first lower swash plate moves, the first upper swash plate moves along with the first lower swash plate. The first upper swash plate includes a plurality of upper linkages, and the upper linkages control movements of the first blade and the second blade. Further, the second swash plate includes a second upper swash plate and a second lower swash plate coupled to each other. The second lower swash plate is coupled to the three linkages through ball points. The three linkages coupled to the second lower swash plate control the second lower swash plate by using three servos. When the second lower swash plate moves, the second upper swash plate moves along with the second lower swash plate. The second upper swash plate includes a plurality of upper linkages, and the upper linkages control movements of the third blade and the fourth blade.

In one embodiment, each of the first swash plate part and the second swash plate part is controlled by three servos, which are six servos in total, and the servos are controlled by a hex-rotor controller.

### Advantageous Effects

According to one aspect of the present invention, it is possible to transfer high power without requiring development of a separate controller and reduce the numbers of gears, shafts, and bearings and bearing housings, thus improving cost and operational efficiency.

### BRIEF DESCRIPTION OF THE DRAWINGS

FIG. 1 is a diagram illustrating a conventional intermeshing rotor helicopter according to a prior art;

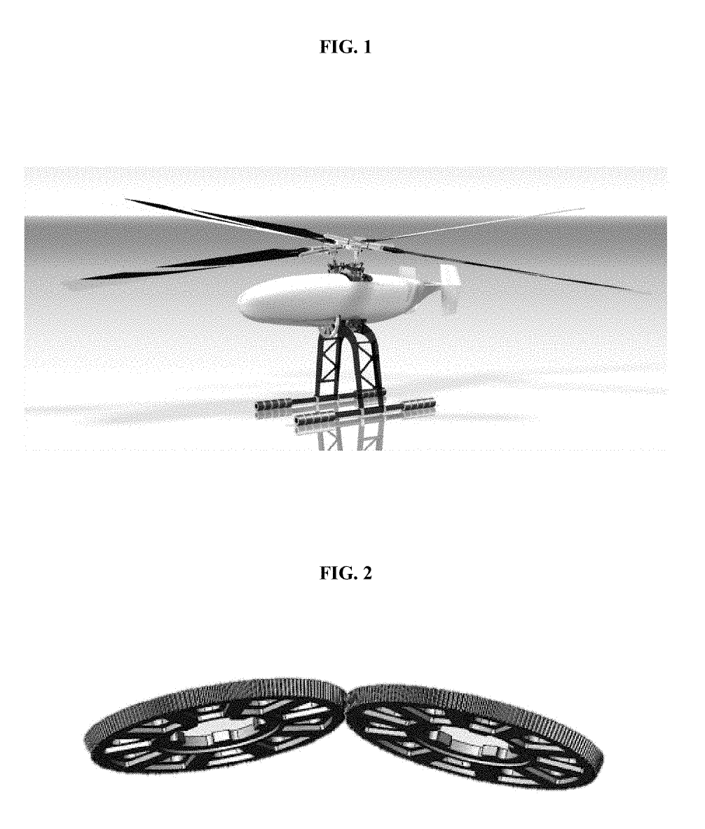

FIG. 2 is a diagram illustrating a driving part of the intermeshing rotor helicopter according to a prior art;

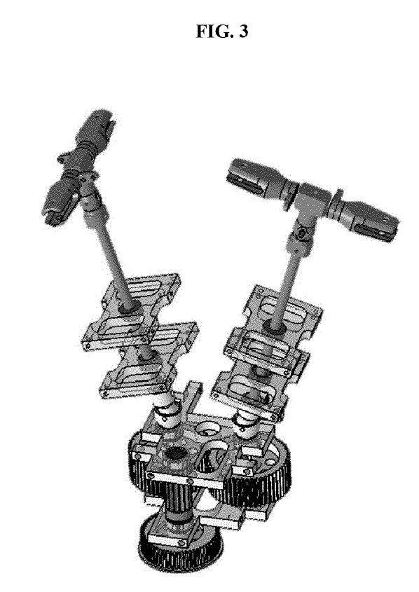

FIG. 3 is a diagram illustrating a portion of the driving part of the intermeshing rotor helicopter according to a prior art;

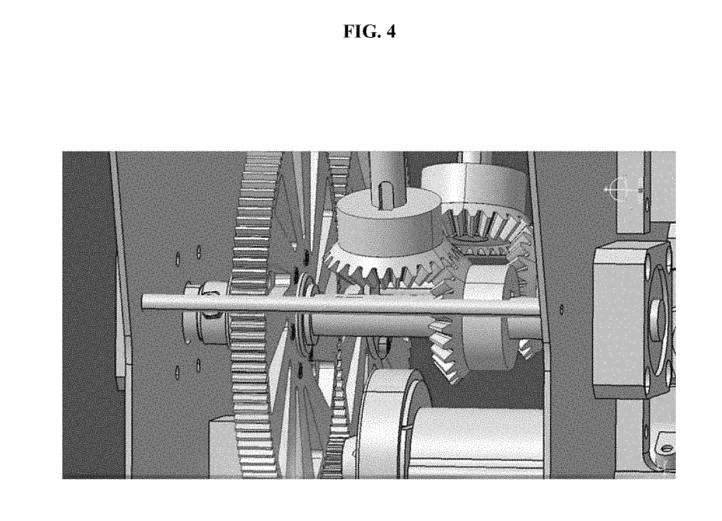

FIG. 4 is a diagram illustrating of a portion the driving part of the intermeshing rotor helicopter according to a prior art;

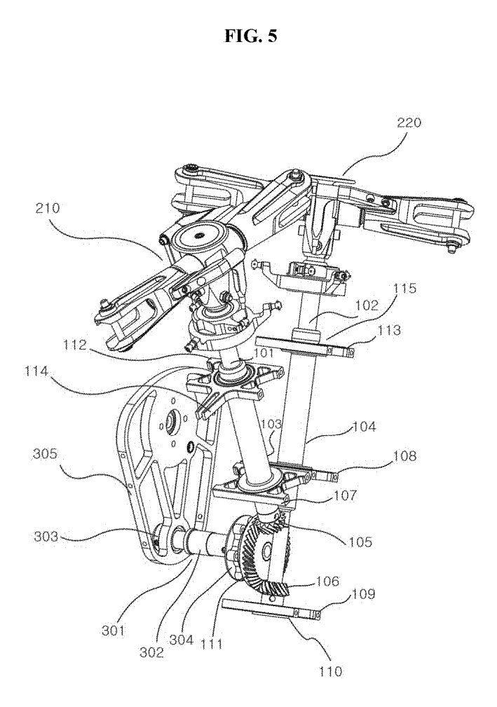

FIGS. 5 and 6 are diagrams illustrating a driving part of an intermeshing rotor helicopter according to an embodiment of the present invention;

FIG. 7 is a diagram illustrating an internal structure of an intermeshing rotor helicopter according to an embodiment of the present invention;

FIG. 8 is a diagram illustrating an internal structure for controlling a blade according to an embodiment of the present invention; and

FIG. 9 is a layout of a swash plate according to an embodiment of the present invention; and

FIG. 10 is a layout of a swash plate according to another embodiment of the present invention.

### BEST MODE FOR CARRYING OUT THE INVENTION

A helicopter according to a preferred embodiment includes: a first rotating wing part comprising a first blade and a second blade; a second rotating wing part comprising a third blade and a fourth blade; a first shaft configured to deliver power to the first rotating wing part; a second shaft configured to deliver power to the second rotating wing part; a first swash plate part configured to control the first blade and the second blade; and a second swash plate part configured to control the third blade and the fourth blade. The first shaft and the second shaft are symmetrically disposed to have a predetermined angle. The first swash plate part is coupled to three linkages through three points which respectively correspond to three vertexes of an equilateral triangle. The second swash plate part has a same shape as the first swash plate part, and respective equilateral triangles of the first swash plate part and the second swash plate part form a star shape when the equilateral triangles move in a horizontal direction and overlap each other.

### MODE FOR CARRYING OUT THE INVENTION

The present invention should not be construed as limited to the embodiments set forth herein. As used herein, the term “and/or” includes any and all combinations of one or more of the associated listed items. The terms used herein is for describing embodiments only, but are not intended to be limiting the present invention.

As used herein, the singular forms are intended to include the plural forms, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

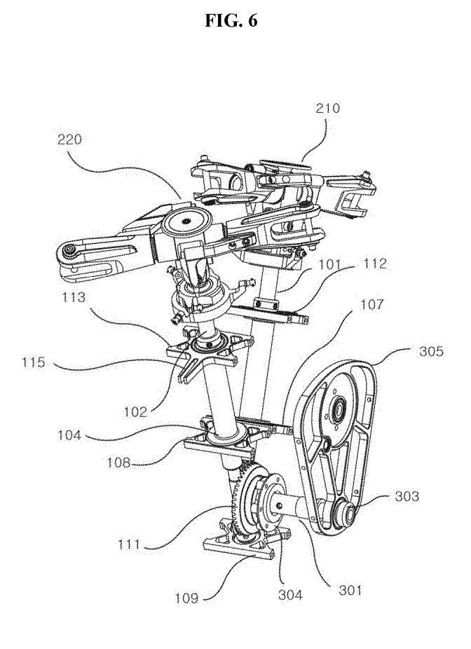

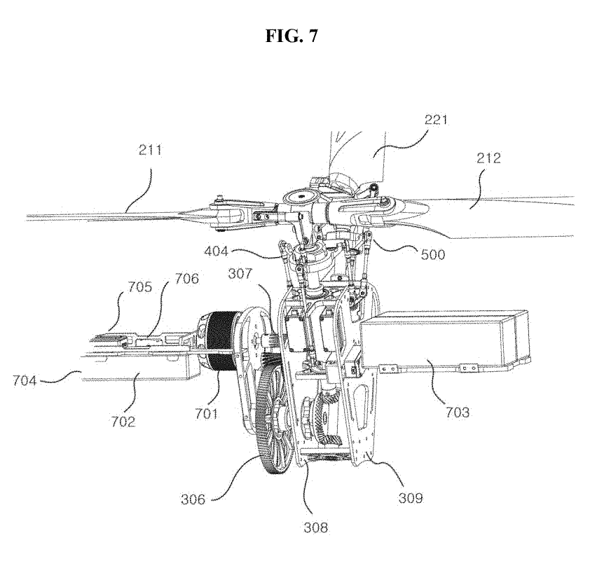

FIGS. 5-7 are diagrams of a driving part of an intermeshing rotor helicopter according to an embodiment of the present invention.

As described above, the intermeshing rotor helicopter is configured to include two shafts positioned in an oblique manner, respective rotating wings (including blade(s)) mounted on each of the shafts. Each shaft is driven by a motor 701.

The intermeshing rotor helicopter according to an embodiment of the present invention includes a first shaft 101 and a second shaft 102. The first shaft 101 is positioned in an oblique manner by a first supporting member 107 including a first bearing housing 103 and a third supporting member 112 including a first linkage guide 114. The second shaft 102 is positioned in an oblique manner by a second supporting member 108 including a second bearing housing 104, a fourth supporting member 113 including a second linkage guide 115 and a fifth supporting member 109 including a third bearing housing 110.

The first shaft 101 and the second shaft 102 are positioned to have a predetermined angle in the top, front and rear views. However, when viewed from the side thereof, the first shaft 101 and the second shaft 102 can be shown to be positioned on the same line. The first and second shafts 101 and 102 are arranged to have an angle at which they are symmetrically positioned.

The first shaft 101 and the second shaft 102 may have different lengths from each other. The length of the first shaft 101 is shorter than the second shaft 102. The difference in length between the shafts 101 and 102 can be determined by respective angles between the shaft(s) and gear(s) of the driving part which will be described later.

The first to fourth supporting members have different lengths one from another according to the lengths of the first shaft 101 and the second shaft 102, and the number of the supporting members can be increased or decreased according to a configuration. The fifth supporting member 109 is coupled to one end of the second shaft 102.

The intermeshing rotor helicopter includes a first pinion gear 105 at one end of the first shaft 101 and a second pinion gear 106 at one end of the second shaft 102. The second pinion gear 106 is positioned above the fifth supporting member 109.

The first pinion gear 105 and the second pinion gear 106 are gear-coupled to a main bevel gear 111. An end of the main bevel gear 111 is in circle shape and provided in plane without slopes except mountain portions of the gears. Further, the gears of the main bevel gear 111 are formed at an outer portion of the circle. In addition, the first pinion gear 105 and the second pinion gear 106 are gear-coupled on the same plane as the end of the main bevel gear 111.

For example, as the first shaft 101 is shorter than the second shaft 102, the first pinion gear 105 is gear-coupled to an upper portion of the main bevel gear 111. In addition, as the second shaft 102 is longer than the first shaft 101, the second pinion gear 106 is gear-coupled to a lower portion of the main bevel gear 111. Accurate position for the gear-couplings can be determined based on angles of the shafts, gear ratios, etc.

The main bevel gear 111 is coupled to a third shaft 301. The third shaft 301 includes an one-way bearing 302 and a main spur gear. The third shaft 301 is embedded into an opposite end to the end of the main bevel gear 111 without protruding from the end of the main bevel gear 111. If a space is allowed, the third shaft 301 is adapted to be fixed by penetrating the main bevel gear 111. However, in this case, gear ratios, sizes, etc. of the main bevel gear 111, the first pinion gear 105 and the second pinion gear 106 can be considered. For example, in case of a compact drone being considered, it may be difficult to have the third shaft 301 penetrate the main bevel gear 111 due to its spatial restriction.

The third shaft 301 includes a fourth bearing housing 304. The fourth bearing housing 304 is provided at a location next the main bevel gear 111 to serve for supporting and fixing the third shaft 301 to a front plate 308. Further, the first to fifth supporting members are provided to be coupled to the front plate 308 and a rear plate 309. A fifth bearing housing 305 is positioned at another end of the third shaft 301, and the third shaft 301 is fixed to the fifth bearing housing 305 through a fixing member 303.

The main spur gear and the one-way clutch 302 are positioned between the fifth bearing housing 305 the front plate 308. The main spur gear is gear-coupled to a motor 701 through a reduction gear part 307. This complex structure can be configured more effectively using planetary gears.

The intermeshing rotor helicopter may further include a motor 701, a servo, a control unit 706, a communication unit 705, a first battery 702, a second battery 703, various components for landing, etc.

As described above, the intermeshing rotor helicopter is based on a control technology for a driving unit driving the shafts positioned in an oblique manner and two rotating wings.

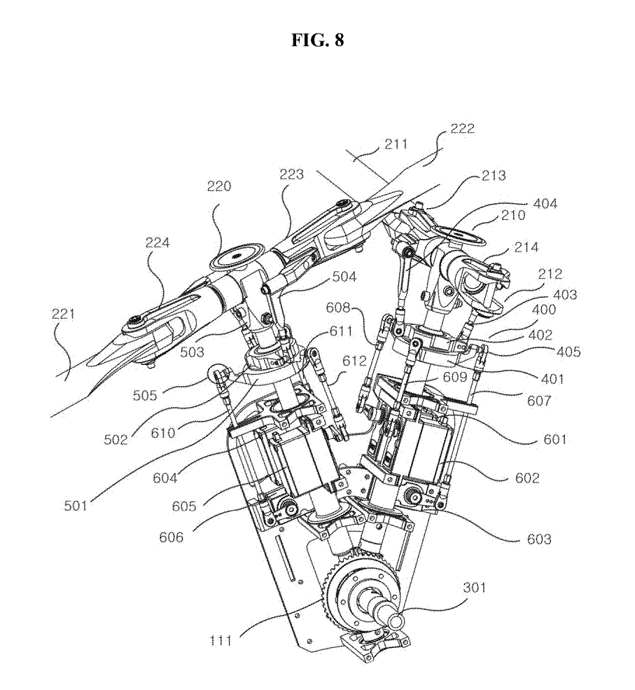

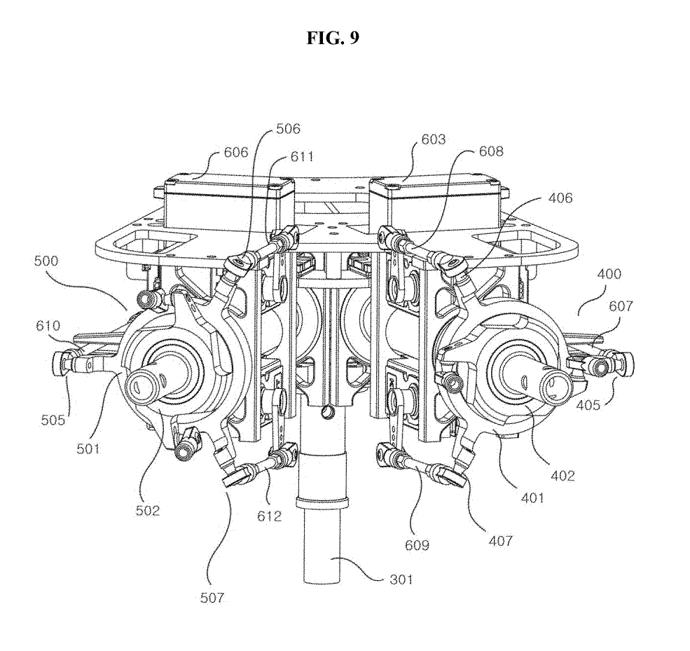

In some embodiments of the present invention with reference to FIGS. 8-10, the internal structure of the intermeshing rotor helicopter includes: a first rotating wing part 210 positioned at another end of the first shaft 101 opposite to the end where the first pinion gear 105 is positioned; and a second rotating wing part 220 positioned at another end of the second shaft 102 opposite to the end where the second pinion gear 106 is positioned.

A first swash plate part 400 and a second swash plate part 500 are used for controlling the first rotating wing part 210 and the second rotating wing part 220, respectively.

The first swash plate part 400 includes a first lower swash plate 401 and a first upper swash plate 402. The second swash plate part 500 includes a second lower swash plate 501 and a second upper swash plate 502. The first lower swash plate 401 is coupled to lower linkages through ball-joints 405 to 407, and the second lower swash plate 501 is coupled to another lower linkages through ball-joints 505 to 507.

For example, a first lower linkage 607 is coupled to the first ball-joint 405, a second lower linkage 608 is coupled to the second ball-joint 406, a third lower linkage 609 is coupled to the third ball-joint 407, a fourth lower linkage 610 is coupled to the fourth ball-joint 505, a fifth lower linkage 611 is coupled to the fifth ball-joint 506, and a sixth lower linkage 612 is coupled to the sixth ball-joint 507.

The first lower linkage 607 is coupled to a first servo 603, the second lower linkage 608 is coupled to a second servo 601, the third lower linkage 609 is coupled to a third servo 602, the fourth lower linkage 610 is coupled to a fourth servo 606, the fifth lower linkage 611 is coupled to a fifth servo 604, and the sixth lower linkage 612 is coupled to a sixth servo 605.

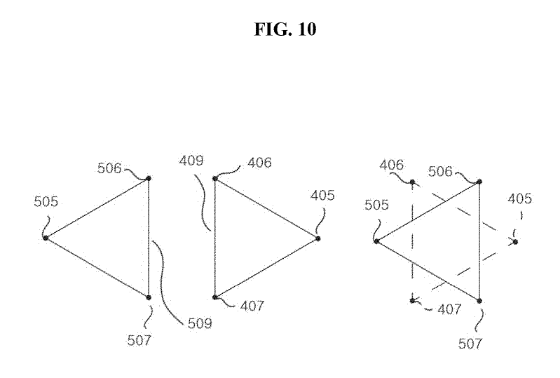

As illustrated in FIG. 10, the first lower swash plate 401 of the first swash plate part 400 is provided such that lines connecting the first to third ball-joints 405 to 407 form an equilateral triangle, and the second lower swash plate 501 of the second swash plate part 500 is provided such that lines connecting the fourth to sixth ball-joints 505 to 507 form an equilateral triangle.

The equilateral triangles form a star shape when they overlap each other. In addition, the equilateral triangles are symmetrical to each other with respect to both x-axis and y-axis, which allows controlling the servos using a universal (or conventional) hex-rotor control unit.

For example, if the swash plates are positioned as explained above, various movements such as yawing, rolling, pitching, rising and lowering are controlled by a single control unit, thus offering huge advantages and effect in terms of cost and economic perspectives.

In addition, if a first line 409 connecting the second ball-joint 406 and the third ball-joint 407 and a second line 509 connecting the fifth ball-joint 506 and the sixth ball-joint 507 are provided to be symmetrical to each other with respect to x-axis (e.g., line connecting front and rear portions), an occupied area by the swash plate part can be minimized. Further, if the swash plates are arranged symmetrically, mechanics can easily check whether both sides are equally adjusted, so that uniform and intuitive maintenance are possible.

The first upper swash plate 402 and the second upper swash plate 502 are disposed on the respective top surfaces of the first lower swash plate 401 and the second lower swash plate 501 and are coupled to each other and operated together. For example, since the first lower swash plate 401 is coupled to the first upper swash plate 402, when the first lower swash plate 401 moves by the first to third lower linkages, the first upper swash plate 402 moves along with first lower swash plate 401.

The first rotating wing part 210 includes a first blade 211 and a second blade 212. The second rotating wing part 220 includes a third blade 221 and a fourth blade 222. Each of the blades is fixed through a first grip 213, a second grip 214, a third grip 223, and a fourth grip 224. The first grip 213 and the second grip 214 are coupled through a first upper linkage 403 and a second upper linkage 404, respectively. In addition, the third grip 223 and the fourth grip 224 are coupled through a third upper linkage 503 and a fourth upper linkage 504, respectively.

For example, when the lower swash plates move, upper swash plates move along with the corresponding lower swash plates, and when the upper swash plates move, grips move along with the corresponding upper swash plates due to the upper linkages. In addition, when the grips move, the blades move along with the corresponding grips, and thus, the intermeshing rotor helicopter can be controlled along with the movement of the blades.

Structurally, in one embodiment, a swash plate part is divided by an upper swash plate and a lower swash plate which are separate. Here, the upper swash plate is required to rotate in a same speed as the rotation speed of a rotor, and the lower swash plate is required to be completely tied to the linkages without rotating. However, since the linkages are generally connected through ball-joints, if a rotational force (e.g., torque) is applied, the lower swash plate becomes to rotate along with the linkages; in this case, a degree of freedom (DOF) of the lower swash plate is not bound that the helicopter cannot be controlled.

Accordingly, the first linkage guide 114 and the second linkage guide 115 hold the linkage connected to the lower swash plate to prevent the twisting of the linkage and the rotation of the lower swash plate.

Therefore, the first linkage guide 114 and the second linkage guide 115 completely constrain the DOF of the lower switch plates with respect to the rotation, thereby enabling normal control of the helicopter.

In this embodiment, the servo(s) located at both ends is located lower than the other servo(s), and the first and fourth lower linkage 607 and 610 connected to the servo(s) are made longer than the other linkages, so that the first and second linkage guides can be located as far away as possible from the servo-linkage connection and as close as possible to the lower swash plate-linkage joint. Such a structure is mechanically the most stable and allows precisely preventing rotation. The embodiment described above is provided with two shafts and two rotating wings.

The embodiment(s) of the present invention is also applicable to an intermeshing rotor helicopter where the structure with two shafts is present in multiples.

Intermeshing rotor helicopter using the universal (conventional) multi-rotor controller (e.g., hex-rotor controller) is operated as follows. A receiver mounted on the helicopter receives commands (Rolling, Pitching, Yawing, Rising/Lowering) from a transmitter of the user and sends signals to a multi-rotor controller (e.g., main controller). The multi-rotor controller mixes the received signal to the six servos to finally be able to control the intermeshing rotor helicopter.

In addition, a global positional system (GPS) module and an IMU module mounted on the aircraft determine aircraft information (e.g., position, attitude, etc.) and send the determined information to the multi-rotor controller to enable more stable and precise control.

Here, the conventional multi-rotors mainly use brushless DC (BLDC) motor instead of servos, and the BLDC motor can easily be modified by exchanging jacks of wires when the forward/reverse rotation are problematic. However, the multi-rotor using the servos can solve the forward/reverse rotation problem of the servos by using a programmable servo capable of changing the forward/reverse rotation or by installing a signal receiver in the middle.

In addition, since the multi-rotor controller and the servos of the intermeshing rotor helicopter is powered from an auxiliary battery which is separate from the main power source supplied to the main motor, the multi-rotor controller and the servo(s) can operate normally to maintain the position of the helicopter. Except for the main motor, all electronic equipment of the helicopter is supplied with power divided from the auxiliary battery divided through the power distribution unit (PMU).

1. A helicopter, comprising:
a first rotating wing part comprising a first blade and a second blade;
a second rotating wing part comprising a third blade and a fourth blade;
a first shaft configured to deliver power to the first rotating wing part;
a second shaft configured to deliver power to the second rotating wing part, wherein the first shaft and the second shaft are symmetrically disposed to have a predetermined angle;
a first swash plate part configured to control the first blade and the second blade; and
a second swash plate part configured to control the third blade and the fourth blade,
wherein the first swash plate part is coupled to a first group of three linkages through three points which respectively correspond to three vertexes of a first equilateral triangle,
wherein the second swash plate part is coupled to a second group of three linkages through three points which respectively correspond to three vertexes of a second equilateral triangle, and
wherein the first equilateral triangle and the second equilateral triangle form a star shape when the first equilateral triangle and the second equilateral triangle move in a horizontal direction and overlap each other.

2. The helicopter of claim 1, wherein the first swash plate part comprises a first upper swash plate and a first lower swash plate coupled to each other,
wherein the first lower swash plate is coupled to the first group of three linkages through ball points,
wherein the first group of three linkages control the first lower swash plate by using a first group of three servos,
wherein when the first lower swash plate moves, the first upper swash plate moves along with the first lower swash plate,
wherein the first upper swash plate comprises a plurality of upper linkages, and the upper linkages control movements of the first blade and the second blade,
wherein the second swash plate part comprises a second upper swash plate and a second lower swash plate coupled to each other,
wherein the second lower swash plate is coupled to the second group of three linkages through ball points,
wherein the second group of three linkages coupled to the second lower swash plate control the second lower swash plate by using a second group of three servos,
wherein when the second lower swash plate moves, the second upper swash plate moves along with the second lower swash plate, and
wherein the second upper swash plate comprises a second group of upper linkages, and the second group of upper linkages control movements of the third blade and the fourth blade.

3. The helicopter of claim 1, wherein the first swash plate part is controlled by the first group of servos and the second swash plate part is controlled by the second group of servos, and the first group of servos and the second group of servos are controlled by a hexa-rotor controller.
